(19) United States
(12) Patent Application Publication
(10) Pub. No.: US 2025/0031605 A1
(43) Pub. Date: Jan. 30, 2025

(54) SEED PLUG PLANTING SYSTEM, APPARATUS, AND METHOD

(71) Applicant: Farm Right, LLC, Shannon City, IA (US)

(72) Inventor: Cody Shay, Shannon City, IA (US)

(73) Assignee: Farm Right, LLC, Shannon City, IA (US)

(21) Appl. No.: 18/709,307

(22) PCT Filed: Nov. 9, 2022
(86) PCT No.: PCT/US2022/079579

§ 371 Date: May 10, 2024

Related U.S. Application Data
(60) Provisional application No. 63/277,726, filed on Nov. 10, 2021.

(51) Int. Cl. A01C 21/00; A01C 7/00

(52) U.S. Cl. CPC A01C 21/005; A01C 7/006

(57) ABSTRACT

A seed plug planting system, method and apparatus comprising a seed plug containing a local environment surrounding a seed. The local environment comprises one or more inputs including, a soil input and a fertilizer input. The seed plug is planted into a global environment, such as field, by a planter. The planter plants the seed plug at a certain depth and orientation relative to the surface of the global environment.

### CROSS-REFERENCE TO RELATED APPLICATIONS

This application claims priority under 35 U.S.C. § 119 to provisional application Ser. No. 63/277,726 filed Nov. 10, 2021, which is incorporated by reference in their entirety.

### FIELD OF THE INVENTION

The present invention relates to planting seeds. More particularly, but not exclusively, the present invention relates to a seed plug planting system, apparatus, and method.

### BACKGROUND

Traditional and even modernized farming practices involve inputs (e.g., fuel, equipment, machine hours, manhours, chemical biocides, biologicals) that generally are used and expended across the entirety of a field during planting a crop. Not all these inputs, collectively or individually, directly or indirectly, benefit the crop and plant yield. Therefore, there is a need to change the practice of farming so that all inputs, collectively and individually, directly and indirectly, benefit the crop and plant yield, while significantly decreasing the overall expenditure of inputs for growing crops. To increase the overall health and yield of a crop, farmers till their fields and use large amounts of chemicals or fertilizers on the field to promote the growth of the crop. However, tilling strips the field of the first six to ten inches of soil increasing runoff of the chemicals and fertilizers into streams and other water sources. Therefore, what is need is a method, system, and apparatus for containing seeds within a local environment having small amounts chemicals and fertilizer and planting the local environment into the field without introducing large amounts of chemicals and fertilizers.

### SUMMARY

Therefore, it is a primary object, feature, or advantage of the present invention to improve over the state of the art.

It is a further object, feature, or advantage of the present invention to prevent runoff by using fertilizer in a small local environment instead of over a large field.

It is a still further object, feature, or advantage of the present invention to control the depth and orientation a seed is planted at by controlling the depth and orientation of the seed plug.

Another object, feature, or advantage is to create a desired local environment of a seed that promotes the seed's growth.

In one aspect of the present invention a seed plug planting system is disclosed. The seed plug planting system includes a seed plug having a top opposing a bottom and at least one side. The at least one side is adjacent to the top and the bottom, The seed plug includes a plurality of inputs comprising a local environment. At least one input is a seed and at least one input is a soil input. The soil input is determined by the global environment. The seed plug planting system also includes a planter, wherein the planter controls the depth of the seed plug in a soil of the global environment. The planter controls the orientation of the seed plug in the soil of the global environment.

In another aspect of the disclosure a seed plug apparatus is disclosed. The seed plug includes a top opposing a bottom, an interior opposing an exterior and at least one side. The interior of the seed plug comprises a local environment for growing a seed. The seed plug also includes a soil input disposed in the interior of the seed plug and a seed disposed in the interior of the seed plug. The soil input is at least above or below the seed. The seed plug includes a fertilizer input mixed with the soil input. The fertilizer input and soil input are selected based on a global environment. The seed plug is planted in the global environment and the depth and orientation of the seed plug in a soil of the global environment is controlled by a planter. An aggregator of the planter may mix one or more of the plurality of inputs together within the seed plug prior to planting.

In another aspect of the present invention, a method for creating a local environment within a seed plug planting system is disclosed. The method includes determining a plurality of factors of a global environment and selecting a plurality of inputs based of the plurality of factors of the global environment wherein the plurality of inputs comprise a seed and a soil input. The method also includes placing a first part of the soil input in a seed plug, placing the seed in the seed plug, and covering the seed with a second part of the soil input to create a local environment of the seed. A planter may mix soil input and seed together prior to planting the seed plug. Lastly, the method includes planting the seed plug at a depth and an orientation relative to a surface of a soil of the global environment by the planter.

One or more of these and/or other objects, features, or advantages of the present invention will become apparent from the specification and claims that follow. No single aspect need provide each and every object, feature, or advantage. Different aspects may have different objects, features, or advantages. Therefore, the present invention is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is a pictorial representation of the seed plug;

FIG. 2 is an illustration of the seed plug;

FIG. 3 is another illustration of the seed plug;

FIG. 4 is an illustration of the seed plug planting system;

FIG. 5 is a flow chart of a method for planting the seed plug;

FIG. 6 is another flow chart of a method for providing inputs that directly or indirectly benefit the crop yield;

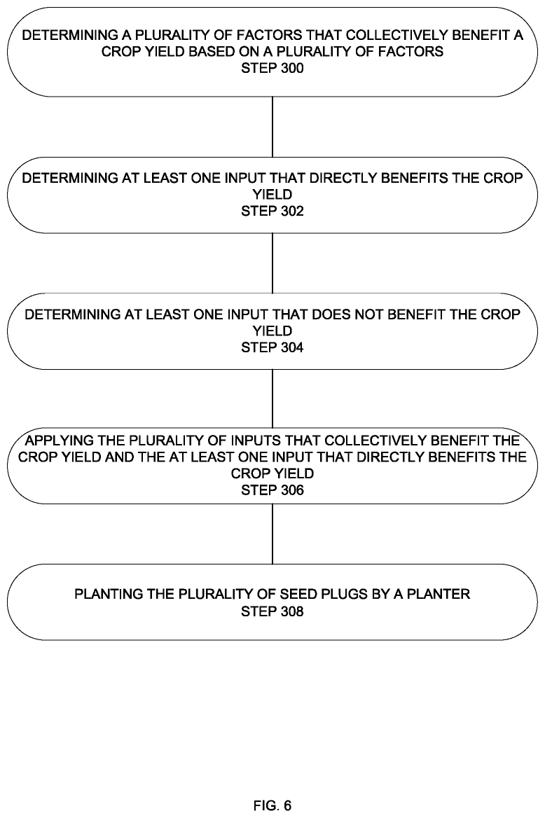

FIG. 7 is an illustration of a tilled field and a field planted with the seed plugs; and

FIG. 8 is an illustration of a farm field and seed plugs.

### DETAILED DESCRIPTION

When improperly managed agricultural runoff from farming can pollute lakes, rivers, and marine beaches and contaminate groundwater. Agricultural nonpoint source pollution is one of the leading sources of water quality impacts, impairments to wetlands, and a major contributor to contamination of groundwater and estuaries. Plowing to often or at wrong times, application of excessive use of pesticides, irrigation, fertilizers, micronutrients, or other chemicals over large portions of a crop, field, or acreage. Sediment is a common runoff pollutant that is washed off fields and flows into nearby water sources. Fertilizers, pesticides, micronutrients, metals, and other chemicals are often attached to soil particles that runoff the soil from farmers' fields.

Different farming techniques including conventional tilling release nitrous oxide, a greenhouse gas, from soil. Furthermore, fertilizer manufacturing releases carbon dioxide into the atmosphere. Tilling causes the loss of billions of tons of fertile soil every year. Tilling turns over the first six to ten inches of soil prior to planting crops. It loosens and removes any plant matter covering the soil, leaving the soil bare and less able to absorb water and nutrients. Tilling can displace microbes and insects necessary for healthy soil, converting healthy soil into an unhealthy growing medium requiring additional fertilizers and chemicals.

Vertical tilling was created to address different needs from conventional tilling, reducing horizontal movement of the soil. Vertical tilling lightly tills the soil cutting up crop residue and mixing it into the first few inches of soil while leaving large quantities of crop residue on the soil. Strip tilling creates 6-to 12-inch-wide rows of tilled soil. The areas between the tilled portions of soil are left undisturbed. Strip tilling creates 6-to 12-inch-wide rows of tilled soil. The areas between the tilled portions of soil are left undisturbed. Reduced tilling leaves a percentage of crop residue on top of the soil using a reduction in the depth, degree, or frequency of tilling. However, vertical tilling, reduced tilling and strip-tilling can still destroy the soil environment, limiting the soil's ability to function properly and leaves the topsoil susceptible to erosion and run off.

No-till methods have been developed to help resolve the problems caused by traditional tilling. No-till methods allow the soil structure to stay intact and protect the soil. The improved soil structure and soil cover increase the ability of the soil to absorb water and nutrients reducing erosion and runoff. Seed are planted through the remains of residue crops, including green cover crops, or v-slots and seed furrows can be drilled. The furrows must be at an appropriate depth for successful germination. However, no-till methods can increase the use of chemicals, such as fertilizer to remove weeds.

On-seed treatments, prior to planting, can be used to promote seed germination and prevent or lessen the impact of insects and plant diseased. However, the seed treatment may not provide protection long enough for the seed to germinate and grow. Therefore, what is need is a method, apparatus, and system for planting seeds at a specific depth and orientation relative to the soil surface and treating the small environment surrounding the seeds instead of treating the entire field.

However, these methods of farming involve a variety of inputs or factors (e.g., fuel, equipment, machine hours, manhours, cost, buildings, governmental policies, public policies or opinions, transport, knowledge, electricity, farming style, irrigation, chemical biocides, biologicals) that generally are used and expended across the entirety of a field during planting a crop. Not all these inputs or factors, collectively or individually, directly or indirectly, benefit the crop and plant yield. Therefore, there is a need to change the practice of farming so that all inputs, collectively and individually, directly and indirectly, benefit the crop and plant yield, while significantly decreasing the overall expenditure of inputs for growing crops.

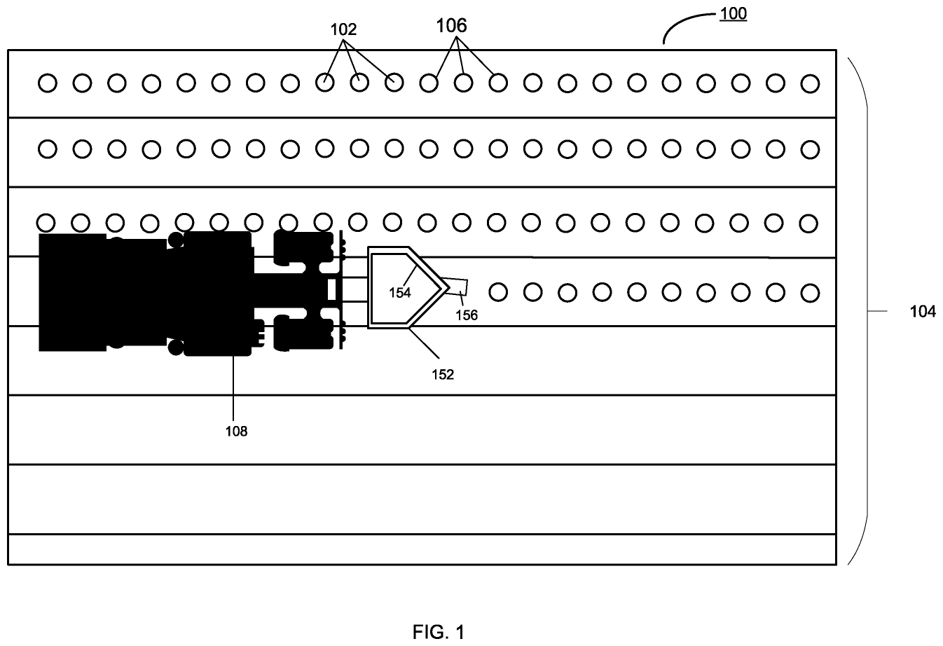

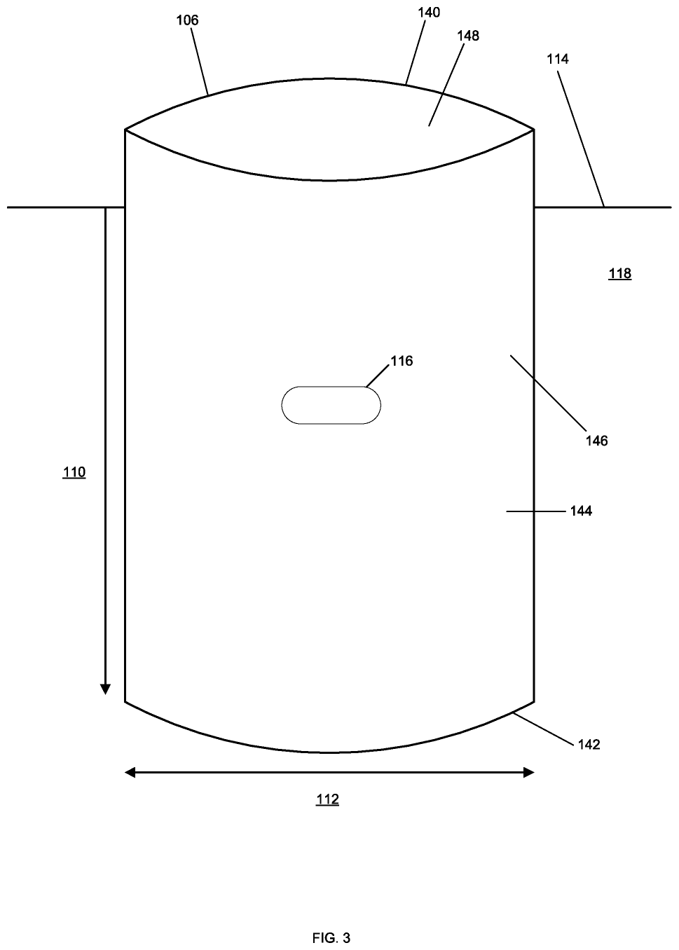

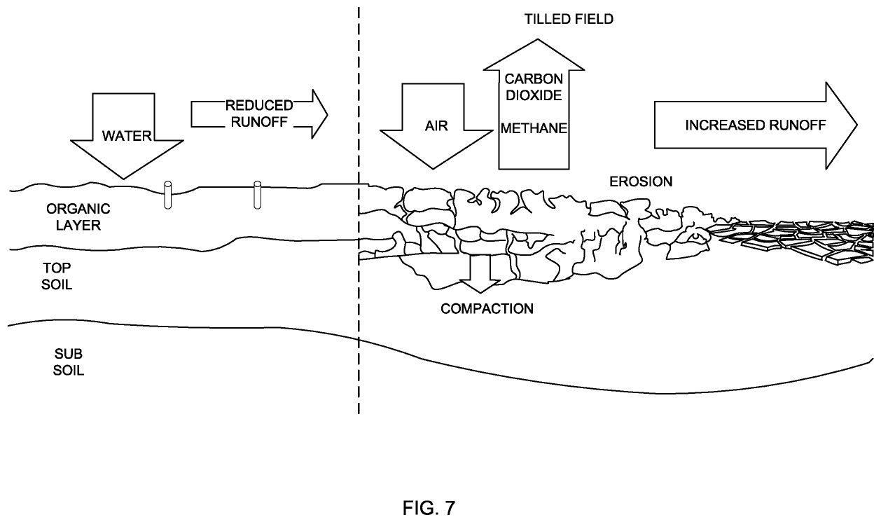

A seed plug planting system 100, as shown in FIG. 1, allows a localized environment 102 for growing a seed to be planted in a larger global environment 104. The localized environment 102 is housed in a seed plug 106 can contain a variety of inputs including chemical inputs and fertilizer inputs that directly or in directly benefit the seed contained in the seed plug and the crop or plant yield. Housing the variety of inputs in seed plug 106 lessens the potential for chemical runoff and the carbon footprint. The seed plug planting system 100 has a seed plug 106 and a planter 108 for planting the seed plug 106. The planter 108 controls the depth 110 and orientation 112 of the seed plug 106 is planted at relative to the surface of the soil of global environment 114, as shown in FIG. 3. Furthermore, by containing all beneficial inputs in the seed plug, the cost of purchasing the inputs decreases as the amount needed decreases due to the small environment. As illustrated in FIG. 7, the seed plug planting system 100 reduces runoff and does not compact the soil. The organic layer of the soil is preserved with little to no damage along with the top soil. When a tilling method of planting is used, the soil compacts damaging or compacting the organic layer of soil into the topsoil, increasing erosion. The top of the soil may become harder and crack. The global environment may require additional fertilizers or other inputs to provide a better environment for growing plants, increasing chemical runoff. In addition, the tilled environment may release carbon dioxide and methane into the air increasing greenhouse gases.

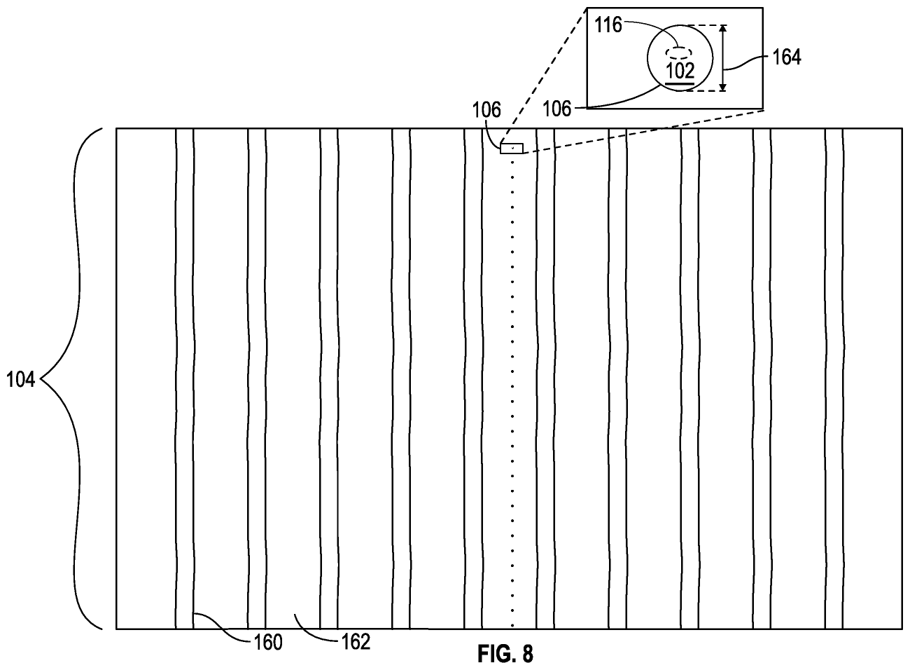

FIG. 8 illustrates the size difference between the global environment 104 and the seed plug. When the seed plug planting method and system is utilized, the seed plugs 106 are spaced apart, such as five to six inches apart. An acre may hold 32,000 corn seeds housed in the seed plugs 106 or 140,000 soybean seeds in the seed plugs. More soybeans may be planted due to less emergence issues then the corn. The diameter of the seed plug 164 may change based on the type of seed 116 in the seed plug. For example, a corn seed housed in the seed plug 106 may require a seed plug 106 with a larger diameter than a soybean seed housed in the seed plug 106. The seed plugs may be planted in furrows 160 created by the planting machinery that are in between evenly spaced ridges 162.

The seed plug 106 provides a small, localized environment 104 surrounding a seed 116 that can be planted at a specific orientation 112 and depth 110 relative to the soil surface 114 as well as allowing the localized environment 102 surrounding the seed 116 within the seed plug 106 to include a customized environment allowing the seed 116 to germinate without treating the entire field or global environment 104 and without wasting large amount of manpower to apply the input to the entire field. The seed plug 106 may include a casing that houses the localized plant environment. The localized environment may include the seed or a plurality of seeds, nutrients, fertilizer, soil or other growth medium, chemicals, biological materials, organic matter, or a casing or housing surrounding the localized environment 102. The localized environment limits or prevents runoff of the inputs such as the nutrients, fertilizer, soil, chemicals, biological materials, organic matter, into the global environment, instead keeping the inputs localized. The seed plug 106 is highly customizable or tailorable allowing a farmer or gardener to customize the local environment 102 based off the global environment 104 or field environment 104 or the seed type 116. In some aspects, all the inputs or additions to the localized environment 102 can be changed while in other aspects only one addition or input may be changed. The seed plug 106 may have one or more inputs including the casing to create the ideal local environment 102 for the seed 116. The overall health, viability, and yield of the seed 116 is based off the localized environment 102, and not exclusively based on the soil conditions within any one field in the global environment 104 or controlling the soil 118 conditions of the entire field in the global environment 104.

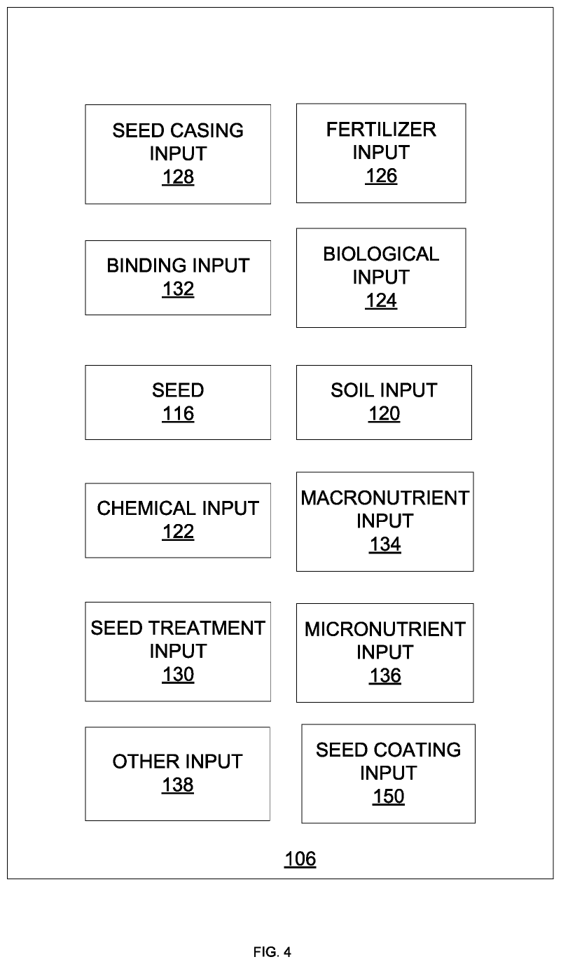

A variety of factors can determine what inputs should be placed in the seed plug 106 or whether the seed plug 106 should have a casing. The factors can be based on the overall health, viability, and yield of the seed 116 by creating a desired environment using the inputs. The factors may include what type of crop or seed 116 is being planted, the type of planting whether its traditional cropping, relay cropping or gardening, the field history, the current conditions of the field, the predicted conditions of the field, the amount of water applied to the field, the type of water application, the interactions between the desired inputs, the number of seed plugs 106 being planted, the distance of the seed plugs 106 from one another, the depth 110 of each seed plug 106 relative to the surface of the field 114, and the orientation 112 of the seed plug 106 relative to the surface of the field 114. The inputs can include the soil input 120, the seed 116, chemical inputs 122, biological inputs 124, fertilizer inputs 126, seed casing inputs 128, seed treatment inputs 130, binding input 132, macronutrient inputs 134, micronutrient inputs 136, the seed coating input, or other inputs 138, as shown in FIG. 4. Other factors or inputs may include the amount of fuel required to apply the input to the entire field, the equipment need to apply the input to the entire field, machine hours, manhours, the cost of running the machinery, the cost of hiring employees or contractors to apply the input, the cost of large amounts of the input, and how much of the input will actually benefit or reach the crop or seed 116.

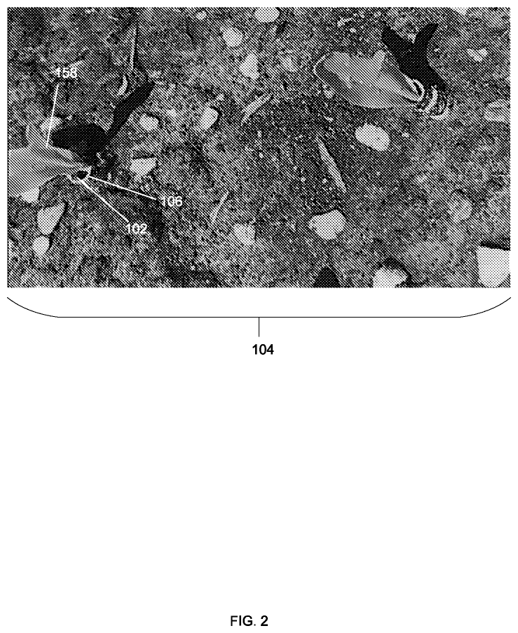

The seed plug 106 may have a top part 140 opposing a bottom part 142 and at least one side 144 having an exterior surface 146 opposing an interior surface 148 as shown in FIG. 3. The seed plug 106 may have rounded body or at least a first side opposing a second side and a third side opposing a fourth side. There may be additional sides to the seed plug 106. The shape of the seed plugs 106 may be designed based on the global environment 104. The top 140 or bottom 142 of the seed plug 106 may be open or have one or more openings that allow the germinated seed 116 to grow out of the seed plug 106 or the additives to mix with a small part of the global environment 104. The top 140 may be planted above the surface 114 of the soil in the global environment 104 exposing the local environment 102 inside the seed plug 106 to air, as shown in FIGS. 2 and 3. After the seed 116 germinates the plant may grow out of the top 140 of the seed casing. The bottom 142 of the seed plug may be planted in the soil 118 of the global environment. The roots of the seed 116 may grow out of the bottom 142 of the seed plug and into the global environment's soil 118.

The seed plug 106 may have a seed casing input 128. The seed casing input 128 may contain the localized environment 102. The seed casing input 128 may have a cylindrical shape, circular shape, or any other geometric shape conducive for planting the seed plug 106 into a field while controlling the depth 110 and orientation 112 of the seed plug 106 relative to the surface of the global environment 114, such as the farmer's field. The seed casing input 128 may be removed, disintegrate, or integrate with the global environment 104 after it is no longer need, after a sufficient time period has passed allowing the seed 116 to germinate or begin the germination process, or until the seed 116 no longer needs the protection provided by the seed casing input 128. The seed casing input 128 may be made of a time release material which releases the inputs at different times so that they may reach seed at the proper time in the seed's development. The seed casing input 128 may be made from a material that breaks apart or creates a hole in the material once it receives enough pressure. For example, a bottom of the seed casing input 128, which may be the bottom of the seed plug 142, may break apart or an opening is created when the roots begin to grow towards the bottom of the seed plug 142. This provides the roots with the ability to grow outside the seed plug 106 and into the global environment 104 if needed. The material of the seed casing input 128 may also be biodegradable, allowing bacteria or other living organism in the global environment 104 or in the local environment 102 to degrade the seed casing input 128 over time. The seed casing input 128 may also be made of netting, canvas, tape, cloth, crop residue, biological materials, wood, plastic, soil, or a binder material, bonding agents, adhesives, woven materials, non-woven materials, synthetic fibers, non-synthetic fibers, one or more liquids, or prefabricated materials. The soil may be the same soil 118 as the global environment compacted to hold the local environment 102 inside the seed casing input 128. The material of the seed casing input 128 may be water absorbent allowing water from the global environment to flow into the local environment through the seed casing input 128 to reach the seed.

In some aspects, an exterior surface of the seed casing input 128, which may be the exterior surface of the seed plug 146, may be made out of a different material then the interior surface, which may be the interior surface of the seed plug 148. The seed plug 106 may not use a seed casing input 128 to contain the local environment 102. The local environment 102 may be compacted enough to hold its shape until planting or for a specific time after planting or the planter 108 may be designed to plant the seed plug 106 into the ground without disturbing the global environment 104. The seed coating input 128 may have a variety of factors to determine the type of seed casing input 128. The factors may include the type of casing, the integrity of the casing, the uniformity of the casing, the surface properties of the casing, the chemical and non-chemical interactions between the other inputs and the casing, the chemical and non-chemical interactions between the global environment and the casing, the moisture content of the casing, or any other factor affecting the type of casing.

The seed plug 106 may have a binding input 132 that separates the local environment 102 from the global environment 104. The binding input 132 material may be a glue, such as an eco-friendly glue, a biodegradable glue. It can be an adhesive such as petrochemicals, cyanoacrylate polymers, polyurethane, and epoxy, plant-based liquid glue from starches or dextrins, gelatin netting. Creating a strong, biodegradable adhesive from gelatin may include adding sugar, Epsom salt, water, and glycerin. The material of the binding input 132 may be water absorbent allowing water from the global environment 104 to flow into the local environment 102 through the binding input 132 to reach the seed. The binding input 132 may have a variety of factors to determine the type of binding input 132. The factors may include the type of binding, the integrity of the binding, the uniformity of the binding, the surface properties of the binding, the chemical and non-chemical interactions between the other inputs and the binding, the chemical and non-chemical interactions between the global environment and the binding, the moisture content of the binding, or any other factor affecting the type of binding.

The seed plug 106 may have a soil input 120 or a growth medium 120 inside the seed plug 106. The exterior of the seed plug may also comprise the soil input. The soil input 120 may surround the seed 116. The soil input 120 may be the same soil type as the global environment soil 118 or the soil input 120 may be customized to fit the type of seeds 116 or growth requirements of the seed 116. For example, if the global environment 104 is a swamp environment, the soil input 120 of the local environment 102 may include peat moss. The soil input 120 may be sandy soil, clay soil, silt soil, peat soil, chalk soil, loam soil, topsoil, garden soil, potting soil, a combination of any of the soil types, or any other soil that provides the seed 116 with the proper local environment 102.

The soil input 120 may have certain retention properties. Soil can process and hold a considerably amount of water. The pore capacity in the soil allows the soil to retain gasses and moisture. Due to its fine particles, clay soil tends to have a high retention of water. Sandy soils provide easier passage of water through the soil. Clay type, organic content and the soil structure can affect the soil's retention ability. Different seed types and different climates may require a different type of soil for the local environment 102. The soil retention properties or requirements for soil retention properties by the seed 116 may factor into what soil type is selected for the soil input 120.

Other factors that determine the type of soil input 120 into the seed plug 106 can include historical conditions of the global environment, current conditions of global environment, or predictive conditions of the global environment. For example, historical conditions can include past weather conditions, pests and pest levels, diseases, water levels, soil types, soil conditions throughout the growing season, terrain, planting practices and the associated yields, or weeds. Pests can include rootworms, cutworms, aphids, nematodes, white mold, fungus, or any other pests that can negatively affect the growth of the seed. Soil conditions can include nutrient, fertility, temperature, or moisture levels. Current conditions can include current pest types and levels, soil type and conditions, weather conditions, planting date, water levels and water chemistry, weed types and levels, field terrain, global position coordinates of the local environment or the global environment, geographical location of the global environment or the local environment, other location-based conditions, seed availability, nearby pest conditions, nearby weed conditions, nearby water conditions, commodity pricing and other market conditions, planter gas level, or type of planter. Future conditions may include weather forecasts, weather predictions, projected planting date, projected yield of seeds, predicted commodity pricing, other market conditions, predicted pest levels, predicted water levels, or predicted soil conditions.

The soil input 120 may contain additives. The additives can include gypsum to help the soil maintain an aggregated structure, compost to add essential nutrients. The additives may include manure, worm castings, nutrients including iron and humuic acid, organic fertilizer such as bat guano, greensand, comfrey, cover crops, leaf mold, wood chips, magic dirt, plant growth promoters or any other organic materials and non-organic materials that can create an overall healthy local environment for the seed to germinate and grow in.

The seed plug 106 contains a seed 116, or a plurality of seeds 116. The seed 116 may be placed in the middle of other inputs placed in the local environment 102 or placed at a desired location in the seed plug 106 with a specific amount or type of input above the seed, below the seed and to the sides of the seed. The seed type may determine what other inputs are added to the seed plug 106. The seed may be placed at a specific or approximate depth or location in the seed plug allowing the seed to be placed at a specific or approximate depth 110 and orientation 112 relative to the surface of the global environment 104. The seed plug 106 may contain one seed 116 or a plurality of seeds 116. The seeds 116 may be a variety of different types, blends of hybrids, specialty crop seeds, commercial crop seeds, monocotyledon seeds, dicotyledons seeds, gymnosperm seeds, feed crop seeds, fiber crop, seed soil crop seeds, ornamental crop seeds, industrial crop seeds, harvesting crop seeds, or genetically modified seeds.

The seed plug may have a seed coating input 150. Exogenous materials may be applied to the surface of the seed 116 as an exogenous seed coating 150 prior to the seed 116 being placed in the seed plug 106. Coated seeds have a greater surface area than an uncoated seed which increases the seeds 116 contact with the other inputs in the seed plug 106. The exogenous materials may include a seed dressing, a film coating or pelleting. The see coating input 150 may contain plant beneficial microbes such as plant growth promoting bacteria, rhizobia, arbuscular, mycorrhizal fungi, and Trichoderma.

The seed coating input 150 may have a variety of factors to determine what type of coating is applied to the seed. The factors may include the ingredients of the coating, the integrity of the coating, the uniformity of the applied coating, how the coating is applied such as dipping an interior of the seed plug into the coating ingreidents, applying the coating to an exterior surface of the interior of the seed plug to form the exterior of the seed plug or other applications methods, the surface properties of the coating, the chemical interactions between the seed and the coating, the chemical interactions between the coating and the other inputs, the moisture content of the coating, seed type, soil characteristics, regional climate, local pathogens and pests, and application equipment, or any other factor affecting the coating.

The seed plug may have a seed treatment input 130. Seed treatments 130 include any biological organism, nutrient, colorant, or chemical applied directly to the seed. Seed treatments 130 can help control or prevent any number of pests from attacking the seed or help overall seed performance or growth. The seed treatment 130 can include fungicides, insecticides, or additives such as nematicides, inoculants, flow additives, biostimulants, or nutrients. The seed treatment 130 may also include seed enhancements such as colorants, flowability agents including talc or graphite, polishing agents and coatings. The seed treatments may be applied the seed 116 prior to seed 116 being placing in the seed plug 106 or may be an individual seed treatment input 130.

The seed treatment input 130 may have a variety of factors to determine what type of treatment is applied to the seed. The factors may include the ingredients of the treatment, the integrity of the treatment, the uniformity of the applied treatment, the surface properties of the treatment, the chemical and non-chemical interactions between the seed and the treatment, the chemical interactions between the treatment and the other inputs, the moisture content of the coating, seed type, soil characteristics, regional climate, local pathogens and pests, and application equipment, or any other factor affecting the type of treatment.

Another input into the seed plug may be one or more fertilizer inputs 126. The one or more fertilizers input 126 can be placed at a specific location within the seed plug 106, such as above the seed, below the side or to a side of the seed. The fertilizer 126 may be placed at a location in the seed plug 106 where a part of the germinated seed 116 reaches the fertilizer 126 at the proper time. For example, a fertilizer 126 rich in phosphorous may be placed below the seed 116. After the seed germinates, the roots of the seed expand down towards the fertilizer 126, where the fertilizer 126 aid in root growth. The fertilizer 126 may not be as helpful to the growth of the roots if the fertilizer is placed above to the seed 116 and the roots either don't reach the fertilizer 126 because it is too far from the seed 116 or the seed 116 reaches the fertilizer 126 too late and the fertilizer 126 does not promote root growth. The seed plug 106 gives the farmer, gardener, or other user of the seed plug the ability to control the placement of the fertilizer 126 relative to the seed 116. Furthermore, the fertilizer 126 can be placed at a specific location and orientation in the seed plug relative to the surface of the field in the global environment. The fertilizer 126 may be evenly distributed in the seed plug 106. The fertilizer 126 may be absorbed by another input in the seed plug 106 such as the seed or the soil. By having the fertilizer 126 as an input in the seed plug 106, a small amount of fertilizer 126 is used in the local environment 102 instead of using large amounts in the global environment 104 hoping that the fertilizer 126 reaches the seed 116. Thereby reducing the runoff of the fertilizer in the field and reducing the carbon footprint. Energy, machine hours, and fuel usage can be reduced as well. A farmer or user does not have to go over a field multiple times to plant the seed and the second to apply the fertilizer at the appropriate time during growth. The fertilizer input 126 can be an organic fertilizer or a nonorganic or synthetic fertilizer. The fertilizer 126 may be a liquid fertilizer or a granular fertilizer. The fertilizer 126 can be a single nutrient fertilizer, such as an ammonium nitrate, urea, or superphosphate fertilizer. The fertilizer 126 may be a multi-nutrient fertilizer such as a tow component fertilizer, a npk fertilizer or a micronutrient fertilizer. The tow component fertilizers can be monoammonium phosphate fertilizer or diammonium phosphate fertilizer or any other two component fertilizers. The npk fertilizers or three component fertilizers may be fertilizers that include nitrogen, phosphorous and potassium. The fertilizers 126 may be compound fertilizers or blend fertilizers. Organic fertilizers, such as fish emulsions, hydrolyzed liquid fish fertilizer, bone meal, compost, manure, rock phosphate, cottonseed meal, alfalfa meal, blood meal, feather meal, or liquid kelp may be used in the seed plug. The fertilizer 126 may also be a slow or controlled release fertilizer to reach the seed at a specific point in during the seeds growth or to be released after the seed plug has been planted in the global environment.

The fertilizer input 126 may have a variety of factors to determine what type of fertilizer is used or selected. For example, when determining if a fertilizer input is needed and if one is needed the type of fertilizer input some of the factors a user can look at is when is the fertilizer applied to the crop in traditional farming, the type of equipment and manpower typically used to apply the fertilizer to the global environment, the cost associated with purchasing the fertilizer in large amounts or small amounts, the governmental policies associated with the user of the fertilizer, storage of the fertilizer prior to use, transport of the fertilizer. After determining these factors, a type of fertilizer input can be determined. The factors may also include the ingredients of the fertilizer, the consistency of the applied fertilizer, the chemical and non-chemical interactions between the seed and fertilizer, the chemical interactions between the fertilizer and the other inputs, seed type, soil characteristics, regional climate, local pathogens and pests, or any other factor affecting the type of fertilizer.

Another input in the seed plug may be one or more chemical inputs 122. The chemical input 122 can be insecticides, pesticides, fungicides, herbicides, or any other chemicals. Pesticides are any substance used to kill, repel, or control pests such as plants, animals, or insects. Herbicides are any substances used to kill or contain weeds or other unwanted vegetation. Insecticides are any substance used for killing or controlling a single insect to a wide variety of insects. Fungicides are any substance used to kill or control fungus, molds, and mildews. Disinfectant chemicals can be used as a chemical input 122 to prevent the spread of bacteria. The one or more chemical inputs 122 may be a biocide for killing, controlling a harmful organism. The chemical input 122 may be biodegradable allowing other inputs in the seed plug 106 to break down the chemical input into harmless compounds once the chemical input's use is no longer necessary. The use of the chemical input 122 in the seed plug 106 as part of the local environment 102 of the seed 116, prevents or lessens the farmer from using vast amounts of chemicals in the global environment 104, thereby lessening the chemical runoff, harmful effects of the chemicals when used in large amounts and the carbon footprint.

The chemical input 122 can be placed at a specific location within the seed plug 106. For example, an insecticide may be placed above the seed 116 relative to the surface of the global environment 114 to prevent an insect from burrowing through the top of the seed plug 106 to reach the seed 116. The use of one or more chemical inputs 122 in the local environment 102 provided by the seed plug 106 prevents or limits the large-scale use of chemicals in the global environment 104, thereby reducing the harmful effects of the chemicals, chemical runoff, and the carbon footprint.

The chemical input 122 may have a variety of factors to determine what type of chemical is used or selected. The factors may include the ingredients of the chemical input, the consistency of the chemical, the chemical and non-chemical interactions between the seed and chemical input, the chemical interactions between the chemical and the other inputs, seed type, soil characteristics, regional climate, local pathogens and pests, or any other factor affecting the type of chemical.

One or more micronutrients may be a micronutrient input 136 in the seed plug 106. The micronutrient inputs 136 can include iron, zinc, molybdenum, manganese, boron, copper, cobalt, and chlorine. Micronutrients can be inputted in a granular form, or the micronutrients can be dissolved by water or another solvent and then. A shortage of micronutrients can lead to deficiencies in plant growth, with different adverse effects on the plant's general state, depending upon which nutrient is missing and to what degree. The one or more micronutrients inputs 136 can be placed at a specific location in the seed plug 106 to reach the seed 116 at the proper time during the seed's growth. By placing the one or more micronutrients 136 in the seed plug 106, the farmer, gardener or user can use small amounts of the micronutrients. The one or more micronutrients 136 are more likely to reach the seed by being placed in the local environment instead of in the global environment. By placing the one or more micronutrients 136 in the seed plug 106, the micronutrients 136 do not have to be placed in the field where they may not reach the seed 116. This prevents large amounts of micronutrients from oversaturated the field creating unhealthy soil conditions and flowing out of the field into water. The micronutrient input 136 may have a variety of factors to determine what type of micronutrient is used or selected. The factors may include the seed type, soil characteristics, regional climate, interactions with the other inputs, local pathogens and pests, the conditions of the global environment, or any other factor affecting the type of micronutrient.

Another input into the seed plug is one or more macronutrient inputs 134. The macronutrients, nitrogen, potassium, magnesium, calcium, phosphorus, and sulfur are used in relatively large amounts by plants. Macronutrients are essential for a plant to have healthy growth. The one or more macronutrients 134 can be placed at a specific location in the seed plug 106 to reach the seed 116 at the proper time during the seed's growth. By placing the one or more macronutrients 134 in the seed plug 106, the farmer, gardener or user can use small amounts of the macronutrients 134. The one or more macronutrients are more likely to reach the seed by being placed in the local environment 102 instead of in the global environment 104. By placing the one or more macronutrients 134 in the seed plug, the macronutrients 134 do not have to be placed in the field where they may not reach the seed 116. This prevents large amounts of macronutrients from oversaturated the field creating unhealthy soil conditions and flowing out of the field into water. The macronutrient input 134 may have a variety of factors to determine what type of micronutrient is used or selected. The factors may include the seed type, soil characteristics, interactions with the other inputs, regional climate, local pathogens and pests, the conditions of the global environment, or any other factor affecting the type of micronutrient.

Another input can be one or more biological inputs 124. The biological inputs 124 can include microorganisms designed to aid or promote the growth of the seed. The microorganisms can include biofertilizers that contain microbes that live in the rizosphere or on the roots, potassium solubilizing bacteria for releasing potassium into the soil, nitrogen fixing organisms such as Rhizobium bacteria or nutrient-solubilizing organisms such as Mycorrhizal fungi, siderophores. The one or more biological inputs 124 may include microbes that produce plant growth hormones. The microbes may produce gibberellins to help a seed germinate or improve plant growth, auxin to stimulate shoot elongation, control the orientation of seedlings, stimulate root branching, promote the development of fruit, or any other microbe that can promote plant growth. The biological inputs 124 may be biopesticides that keep pathogens in check, such as biofungicides. The biopesticides may prevent pathogen growth by producing antibiotics or other chemicals that kill the bacteria such as bacteriocins, the biopesticides may feed on the pathogen, or the biopesticides may parasitize the pathogen. The biological input 124 may be the Bacillus species which can produce a toxin for naturally killing insects, can be used as a biofungicide, or can prevent other pathogens from colonizing on the roots of the seed. The biopesticide can be Streptomyces, which can act as a biofungicide, or Trichoderma species, which can also act as a biofungicide. The biological input 124 may also include nematodes for controlling insect pests. The biological input 124 may have a variety of factors to determine what type of biological input is used or selected. The factors may include the seed type, soil characteristics, regional climate, interactions with the other inputs, local pathogens and pests, the conditions of the global environment, or any other factor affecting the type of biological input 124.

The seed plug 106 may have one or more inputs that control the dormancy or germination of the seed 116, allowing the seed plug to be planted in the best conditions without the seed germinating early. Seeds need the right environment to germinate. The temperature or alternating temperature, air quality or oxygen levels, moisture, humidity, water conditions, light conditions, drought, salinity, burial depth, soil pH, artificial seed aging, and radiant heat environmental conditions affect whether the seed will germinate or remain dormant. The local environment 102 of the seed plug may control all or some of these factors easier than the global environment 104 to help control when the seed will germinate. Seeds that are buried deeper in the soil are more likely to stay dormant. By controlling the orientation 112 and depth 110 of the seed plug 106, a farmer can control germination and dormancy. The farmer may also control germination or dormancy by adding or adjusting one or more inputs to lengthen a seed's dormancy or jump start a seed's germination. Control of germination may be a factor in selecting the inputs for the seed plug 106. If a farmer is relay cropping, the farmer may plant the seed plugs at a specific time based on the first crop that is growing in the field. The germination of the seeds 116 in the seed plugs 106 containing the second crop may need to be controlled so the growth of the second crop does not affect the growth or harvest of the first crop.

A seed plug planting system 100 can create the desired local environment. The various inputs and features in the disclosure may be used or useful in connection with any device or planter 108 used in planting one or more seeds, including broadcast planters, drill planters, air planters, bulk planters, individual row unit planters, clamshell planters, cone planters, cyclone planters, pneumatic planters, finger planters, plate planters, garden crop planters, a self-propelled planter, and the like, especially those devices that can be used to plant one or more combinations of inputs in the local environment on planter for planting at one or more system.

The seed planting system 100 or planter 108 may have an aggregator 152, as shown in FIG. 1, for combining one or more inputs to form the seed plug 106. The aggregator 152 may be towable and operably connected to the planter 108 or self-propelled. The aggregator may contain one or more hoppers 154 or other containers or holding compartments designed to hold an individual input, one or more inputs, a preloaded seed plug, or an empty plug. The preloaded plug may already include all the inputs necessary or selected for planting or the preloaded plug may include some of the inputs selected for planting and the aggregator combines or mixes the rest of the selected inputs with the preloaded seed plug. For example, there may be a seed plug hopper containing the empty seed plug, a fertilizer hopper containing the fertilizer input, a soil hopper containing the soil input and a seed hopper containing the seed. Each hopper 154 may have a loading system for loading the input or seed plug 106 on to a revolver or into the seed plug 106 located on the revolver. The loading system may be in communication with the historical planting database to determine which inputs should be selected, the amount of the various inputs to added to a plurality of seed plugs 106 or each individual seed plug 106, or what inputs not to select based upon the historical data. The aggregator 152 may use all hoppers 154, one of the hoppers 154, or a selection of hoppers to combine the inputs of the seed plug 106. If the seed plug 106 is preloaded with the desired local environment 102, the revolver moves the seed plug 106 to an ejection tube 156 for planting. The planter 108 or aggregator 152 may determine if the seed plug 106 is preloaded or a user may provide inputs to the planter 108 that the seed plug 106 is preloaded. If the seed plug 106 is unloaded, the seed plug 106 may move from the seed plug hopper to the revolver where the other input hoppers can fill the seed plug 106 with the desired inputs. In some aspects of the present disclosure, the aggregator 152 is in communication with the historical computer database to determine which hoppers should be utilized to fill the seed plug 106. Each input may be added at a controlled rate or in a specific location of the seed plug 106. For example, the seed plug 106 maybe preloaded with a seed casing input 128 then move to the revolver to a soil input 120. The seed plug 106 is filled to a certain point with the soil input 120. The seed plug 106 next moves along the revolver to the seed hopper and a seed 116 is placed in the seed plug 106. The seed plug 106 may move to the fertilizer input hopper to have fertilizer added to the seed plug and then to another soil input hopper to fill the seed plug 106 to the top. While adding a variety of inputs, the aggregator 152 may mix, combine or agitate the seed plug 106 to mix, pour, add or blend the inputs together. Then the seed plug 106 is ejected from the aggregator 152 and planted into the field. The revolver may move in concentric circles slowly lower the seed plug 106 into the ejector 156. The revolver may only move one seed plug 106 at a time or move a plurality of seed plugs 106. The input hoppers 154 may contain more than one type of input. For example, the soil input and the fertilizer input may be contained in the same hopper and mixed at a controlled rate. The fertilizer may be added to the soil at a specific ratio to avoid excess fertilizer. The seed plugs 106 may be used in traditional planting, relay cropping or gardening. The type of planting may factor into what inputs are selected for the local environment.

If the seed plug 106 is preloaded with the desired inputs for the local environment 102. Additional factors to be considered include the manufacturing of the seed plug, the preservation of the seed plug before and after it contains the local environment, and the transportation of the seed plug to a store and to the field. The seed plug 106 may be designed to be manufactured, preserved then transported to the farmer's field.

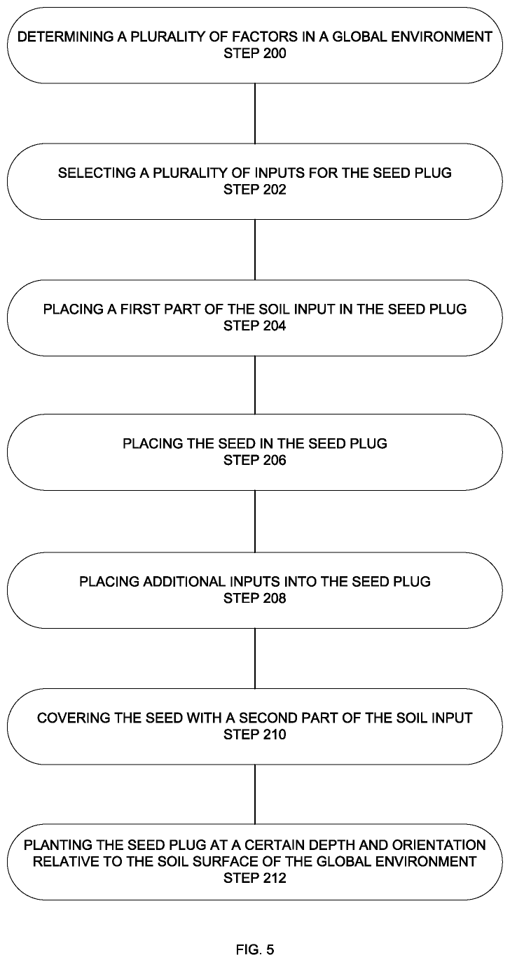

A method for planting the seed plug system is disclosed and shown in FIG. 5. First, a a plurality of inputs based upon the plurality of factors of a global environment are determined (Step 200). A seed plug having a seed and a growth medium may be provided. The factors can include the overall health, viability, and yield of the seed, the type of crop or seed is being planted, the type of planting whether its traditional cropping, relay cropping or gardening, the field history, the current conditions of the field, the predicted conditions of the field, the amount of water applied to the field, the type of water application, the interactions between the desired inputs, the number of seed plugs being planted, the distance of the seed plugs from one another, the depth of each seed plug 106 relative to the surface of the field, and the orientation of the seed plug relative to the surface of the field. The factors may be determined by a processor or a computing system or by the farmer, manufacturer, or gardener. The computing system may store the data used to determine the factors of the global environment to create a historical planting database. The plurality of factors may determine that one or more inputs should not be included as the one or more inputs will not benefit the crop or the seed.

Next, a set of inputs that benefit the crop based on the plurality of inputs of the global environment are selected (Step 202). The set of inputs may collectively or independently benefit the crop. The set of inputs may include all the inputs that comprise the seed plug or a selection of the inputs that comprise the seed plug. For example, the soil input may be present in the seed plug prior to loading the seed plug into the planter, during planters a set of inputs is combined with the soil input. The inputs include the soil input, the seed, chemical inputs, biological inputs, fertilizer inputs, seed casing inputs, seed treatment inputs, binding input, macronutrient inputs, micronutrient inputs or other inputs. The inputs may be selected by a processor or computing system after analyzing the plurality of factors. In some seed plug planting systems, the inputs include at least a seed and a soil input or at least a seed, a soil input, and a fertilizer input.

Next, the first part of the soil input is placed in the seed plug (Step 204). The soil may be placed inside a casing input of the seed plug. Depending on the factors of the global environment the soil input may match the soil type of the global environment, or the soil input may be different than the soil type of the global environment to aid in the growth of the seed. Next, the seed is placed in the seed plug (Step 206). The seed may be placed at a certain depth in the seed plug to enhance or promote the seed's growth. The seed may also be placed next to, or at certain distances from other inputs to increase the seed's health and vitality. Next, additional inputs are inserted or placed into the seed plug or combine with other inputs to form the seed plug. (Step 208). The additional input may be selected from a group of chemical inputs, biological inputs, fertilizer inputs, seed casing inputs, seed binding inputs, seed treatment inputs, macronutrient inputs, and micronutrient inputs. Next, the seed is covered with a second part of the soil input to create the local environment. (Step 210). Lastly, the seed plug is planted a certain depth and orientation in the soil of the global environment relative to the soil's surface (Step 212).

Another method for providing inputs to a crop yield that collectively and independent benefit the seed and crop yield, thereby significantly decreasing the overall expenditure of the inputs for growing crops is disclosed. First, at least one input of a plurality of inputs that collectively benefit a crop is determined based on a plurality of factors (Step 300). These factors can include fuel, equipment, machine hours, manhours, cost, field type, or any other factor. The inputs may include chemical inputs, biological inputs, fertilizer inputs, seed casing inputs, seed binding inputs, seed treatment inputs, macronutrient inputs, and micronutrient inputs. Next, at least one input of a plurality of inputs that independently benefit the crop are determined based on a plurality of factors (Step 302). Next, at least one input from a plurality of benefits that does not benefit the crop is determined based on a plurality of factors (Step 304). Next, the plurality of inputs that benefit the crop yield are applied to the global environment, local environment or field (Step 306). By determined the inputs that directly or indirectly benefit the crop yield, the expenditure of planting and maintaining the crop significantly decreases. Next, the seed plugs are planted by a planter (Step 308). An aggregator of the planter may mix together at least some of the plurality of inputs prior to planting the seed plug.

The invention is not to be limited to the particular aspects described herein. In particular, the invention contemplates numerous variations in a seed plug planting system. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of aspects, processes, or methods of the invention. It is understood that any other modifications, substitutions, and/or additions can be made, which are within the intended spirit and scope of the invention.

What is claimed is:

1. A method for applying a plurality of inputs to a seed plug that benefit a crop, the method comprising:
providing a seed plug comprising at least a seed and a seed growth medium;
determining from a plurality of inputs a set of one or more inputs that benefit a crop produced from the seed based on a plurality of factors;
combining the set of the one or more inputs that benefit the crop with the seed plug by an aggregator of a planter; and
planting the seed plug by the planter;
wherein combining the set of the one or more inputs occurs during planting the seed plug by the planter.

2. The method of claim 1, wherein the plurality of factors comprise at least one of type of the crop or the seed being planted, type of planting, field history, current conditions of a global seed planting environment, predicted conditions of the global seed planting environment, a number of the seed plug being planted, a distance of a first one of the seed plug to a second one of the seed plug, the depth of the seed plug relative to a surface of the soil of the global seed planting environment, and an orientation of the seed plug relative to the surface of the soil of the global seed planting environment.

3. The method of claim 1, wherein the plurality of factors include a set of factors comprising type of machinery, cost inputs, manpower, governmental policies, knowledge, electricity, irrigation and field type.

4. The method of claim 1, wherein a processor selects the set of the one or more inputs from the plurality of inputs.

5. The method of claim 1, wherein at least one of the set of one or more inputs of the plurality of inputs comprises a fertilizer.

6. The method of claim 1, wherein determining from the plurality of inputs a set of the one or more inputs that benefit the crop produced from the seed based on the plurality of factors occurs on the planter during planting.

7. The method of claim 1, wherein the set of one or more inputs selected from the plurality of inputs are applied to a local environment immediately proximate the seed and planted together by the planter.

8. A seed plug planting system for applying a plurality of inputs to a seed plug that benefit a crop, the seed plug planting system comprising
a seed plug having a top opposing a bottom and at least one side, wherein the at least one side is adjacent to the top and the bottom, the seed plug further comprising:
a plurality of inputs comprising a local environment, wherein at least one input is a seed input and at least one input is a soil input;
wherein the soil input is determined by a global environment;
a planter, wherein the planter controls the depth of the seed plug in a soil of the global environment and wherein the planter controls the orientation of the seed plug in the soil of the global environment, the planter further comprising:
an aggregator having at least one hopper for holding the seed plug, wherein the aggregator is operably connected to the planter, wherein the aggregator puts at least the seed input in an interior of the seed plug prior to the planter planting the seed plug.

9. The seed plug planting system of claim 8, wherein the planter is operably connected to a historical planting database for determining the plurality of inputs.

10. The seed plug planting system of claim 8, wherein at least one input of the plurality of inputs is a fertilizer input.

11. The seed plug planting system of claim 8, wherein plurality of inputs comprising the local environment are selected based on at least the global environment.

12. The seed plug planting system of claim 8, wherein the planter creates a hole for the seed plug in the global environment.

13. The seed plug planting system of claim 8, wherein a casing of the seed plug is biodegradable.

14. The seed plug planting system of claim 8, wherein a processor determines the plurality of inputs.

15. A seed plug apparatus for applying a plurality of inputs to a seed plug that benefit a crop, the seed plug apparatus comprising:
a top opposing a bottom, an interior opposing an exterior and at least one side, wherein the interior of the seed plug comprises a local environment for growing a seed;
a soil input disposed in the interior of the seed plug;
a seed disposed in the interior of the seed plug, wherein the soil input is at least above or below the seed;
a fertilizer input, wherein the fertilizer input is mixed with at least a portion of the soil input;
wherein at least the fertilizer input and soil input are selected based on a global environment;
wherein the seed plug is planted in the global environment, wherein the depth and orientation of the seed plug in a soil of the global environment is controlled by a planter;
wherein an aggregator of the planter mixes at least the fertilizer input into the seed plug prior to planting.

16. The seed plug apparatus of claim 15, further comprising:
a casing input for housing the seed, fertilizer input, and soil input,

17. The seed plug apparatus of claim 15, further comprising:
a chemical input, wherein the chemical input is at least one of an insecticide, fungicide, or herbicide.

18. The seed plug apparatus of claim 15, wherein a plurality of factors determine the soil input, wherein the plurality of factors include at least one of historical conditions of the global environment, current conditions of the global environment or predictive conditions of the global environment.

19. The seed plug apparatus of claim 15, wherein the seed has a seed coating.

20. The seed plug apparatus of claim 15, wherein the seed comprises a treated seed.
